(19) United States
(12) Patent Application Publication
(10) Pub. No.: US 2016/0040755 A1
(43) Pub. Date: Feb. 11, 2016

(54) Multi-Speed Gearbox

(71) Applicant: Timo WEHLEN, Friedrichshafen (DE)

(72) Inventor: Timo WEHLEN, Friedrichshafen (DE)

(21) Appl. No.: 14/436,556

(22) PCT Filed: Sep. 4, 2013
(86) PCT No.: PCT/EP2013/068240

§ 371 Date: Apr. 17, 2015

(30) Foreign Application Priority Data
Oct. 17, 2012 (DE) 102012218898.3

(51) Int. Cl. F16H 3/66

(52) U.S. Cl. CPC F16H 3/66; F16H 2003/445

(57) ABSTRACT

Multi-speed transmission in planetary design, in particular an automatic transmission for a motor vehicle, comprising one drive shaft and one output shaft, which are arranged in a housing, four planetary sets, in each case comprising at least one sun gear, one planetary carrier and one ring gear, along with at least six shifting elements, comprising a first brake, a second brake and a third brake and a first clutch, a second clutch and a third clutch, the selective meshing of which brings about different transmission ratio relationships between the drive shaft and the output shaft, such that at least nine forward gears and one reverse gear can be realized, whereas the planetary carrier of the second and fourth planetary sets is arranged in a manner radially offset to the planetary carriers of the second and the fourth planetary gear sets.

### FIELD OF INVENTION

The present invention relates generally to a multi-speed transmission, with which nine forward gears and one reverse gear can be shifted, and which has four planetary sets.

### BACKGROUND

DE 10 2008 000 429 A1 provides a transmission.

The previously known transmission fulfills a wide range of requirements placed on modern multi-speed transmissions. In particular, the transmission may be manufactured with low construction costs, since a relatively small number of elements is required for the formation of the transmission; however, this enables a sequential shifting operation, with which double gearshifts are avoided, such that, during gearshifts in defined gear groups, only one shifting element is changed.

### SUMMARY OF THE INVENTION

The present invention is directed to a multi-speed transmission, which features at least nine forward gears and at least one reverse gear with a sufficient transmission ratio, but which, compared to the transmission conforming to this type, is able to be produced with a transmission length that is smaller in the direction of the drive axle. Moreover, the present subject matter may provide a multi-speed transmission that can be used, in particular, as a hybrid transmission and/or for which the integration of an e-machine and/or a hybrid module with an e-machine, torsion damper system and motor-separating clutch does not unduly increase the transmission length.

Accordingly, the present subject matter proposes a multi-speed transmission in planetary design, which features a drive axle and an output axle, which are arranged in a housing. Furthermore, at least four planetary sets and six power-shifting elements comprising brakes and clutches are provided, the selective meshing of which brings about different transmission ratio relationships between the drive and the output, such that at least nine forward gears and one reverse gear can be realized.

Preferably, the four planetary sets are formed as negative planetary gear sets, thus in each case comprising at least one sun gear, one ring gear, one planetary gear and one planetary carrier. Whereas the sun gear, the ring gear and the planetary carrier are rotatably mounted either rigidly or around a common axis. The at least one planetary gear is rotatably arranged on the planetary carrier, whereas the axis of rotation of the planetary gear is formed in a manner that is fixed relative to the planetary carrier and parallel to the common axis of the planetary carrier, the sun gear and the ring gear. Preferably, a plural number of planets are arranged on the planetary carrier. The planetary gear or planetary gears mesh both with the sun gear and with the ring gear.

Moreover, one or more of the planetary sets may be formed as a positive planetary set, whereas one positive planetary set features at least one first planetary gear and one second planetary gear, whereas the first planetary gear meshes with the sun gear and the second planetary gear meshes with the ring gear. Thereby, the first planetary gear meshes in the second planetary gear.

Preferably, the planetary carriers of the second and the fourth planetary set are arranged radially to the direction of the drive axle, offset to the planetary carriers of the first and the third planetary gear sets. In addition, the axes of rotation of the planetary carriers of the second and fourth planetary set are radially offset to the axes of rotation of the first and fourth planetary sets. The dimensions of the transmission in the axial direction of the drive axle are reduced by the offset, whereby the transmission can also be fitted in more compact installation spaces.

Preferably, the first, third, and fourth planetary set are arranged in the axial direction of the drive shaft in the order of first, third and fourth planetary set or fourth, third and first planetary set. The second planetary set is preferably arranged either between the first and the third planetary set or above the first planetary set, thus on the side of the first planetary set turned away from the drive axle, or on the side of the first planetary set turned away from the third planetary set.

This offset arrangement enables the provision of additional installation space at the entrance of the drive axle and the integration there of additional components, such as a clutch and/or an electric motor.

Preferably, the drive shaft is connectable through the first clutch to the sun gear of the first planetary set, the sun gear of the first planetary set is connectable through the first brake to the housing, the ring gear of the first planetary set is connected to the sun gear of the second planetary set, the planetary carrier of the first planetary set is connected to the planetary carrier of the second planetary set and the ring gear of the third planetary set, the ring gear of the first planetary set and the sun gear of the second planetary set is connectable through a third clutch to the drive shaft, the ring gear of the second planetary set is connected to the housing and the sun gear of the third planetary set is connectable through a third brake to the housing.

With the characteristic that two or more elements are connected to each other, it is particularly understood that the two or more elements feature the same rotational speed, and it is particularly preferable that the two or more elements are connected to the same shaft in a torque-proof manner.

With the characteristic that two or more elements are connectable to each other, it is particularly understood that such elements are detachable from each other, and it is particularly preferable that they are connected to each other by a shifting element.

The special design of the transmission enables a particularly cost-efficient transmission, by which nine forward gears and one reverse gear are enabled.

Preferably, the planetary carrier of the third planetary set is connected to a first idler gear, and is connectable through a second clutch to the drive shaft, whereas the first idler gear meshes in the sun gear of the fourth planetary set. Thereby, the idler gear may be arranged firmly on the shaft or formed in one piece with the shaft, which connects the planetary carrier of the third planetary set with the second clutch. In particular, the idler gear may feature the same rotational speed as the planetary carrier of the third planetary gear set. The idler gear may be formed as a spur gear, but also as a bevel gear, worm gear or any other form of gear wheel.

Moreover, a torque can be transferred from the planetary carrier of the third planetary set to the sun gear of the fourth planetary set through a chain, a belt or the like.

Preferably, the planetary carrier of the fourth planetary set is connected to the output shaft. Thereby, the output shaft may be arranged in a manner radially offset to the drive shaft, such that the transmission is especially suitable for installation transverse to the main axis of the vehicle.

Furthermore, the ring gear of the fourth planetary set may be connected through an idler gear to the sun gear of the third planetary set, and may be connectable through the idler gear and the third brake to the housing.

The output shaft may be equipped with an output gear. Thereby, such an output gear may be a gear wheel, such as a spur gear, but even a gear that enables the transfer of a torque by means of a belt, friction wheel, etc.

Preferably, the second clutch is arranged in the axial direction between the third and the first planetary sets. Whereas the axial direction is perpendicular to the main direction of propagation of the drive axle.

Although all shifting elements can be formed as frictional shifting elements or as claw shifting elements, the third clutch and/or the third brake are particularly suitable for formation as a claw shifting element. Since claw shifting elements typically feature a higher efficiency in the transmission of torque, the efficiency of the transmission is increased through the use of a claw shifting element.

In a specific embodiment, the second brake or the third brake may be formed as start-up elements.

In an additional embodiment, the third clutch and the second brake may be designed as start-up elements.

With “start-up element,” an electric motor may be particularly understood.

In particular, nine gears can be realized in the multi-speed transmission, whereas the first gear arises through the locking of the third clutch and the second and third brakes, the second gear arises through the locking of the first and third brakes and the third clutch, the third gear arises through the locking of the third brake and the first and third clutches, the fourth gear arises through the locking of the third brake and the second clutch and one of the shifting elements of the first brake, second brake, first clutch and third clutch, the fifth gear arises through the locking of the first to third clutches, the sixth gear arises through the locking of the first brake and the second and third clutches, the seventh gear arises through the locking of the second brake and the second and third clutches, the eighth gear arises through the locking of the first and second brakes and the second clutch and the ninth gear arises through the locking of the second brake and the first and second clutches.

Preferably, for a change from one gear into the next higher gear, only one shifting element must be open and one shifting element must be locked.

The reverse gear may arise through the closing of the second and third brakes and the first clutch.

In addition, the transmission in accordance with the invention is designed in such a manner that adaptability to the various drive train arrangements is enabled, both in the direction of the power flow and in spatial terms. The multi-speed transmission in accordance with the invention is particularly suitable for installation in passenger vehicles with front-transverse motorization and a driven front axle.

### BRIEF DESCRIPTION OF THE DRAWINGS

Additional details and advantages of the present invention arise from the following description of an embodiment in conjunction with the drawing. The following is shown in this:

FIG. 1: a schematic view of an exemplary embodiment of a multi-speed transmission in accordance with the invention and

FIG. 2: a shifting diagram for the example of a multi-speed transmission shown in FIG. 1.

### DETAILED DESCRIPTION

Reference will now be made to embodiments of the invention, one of more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

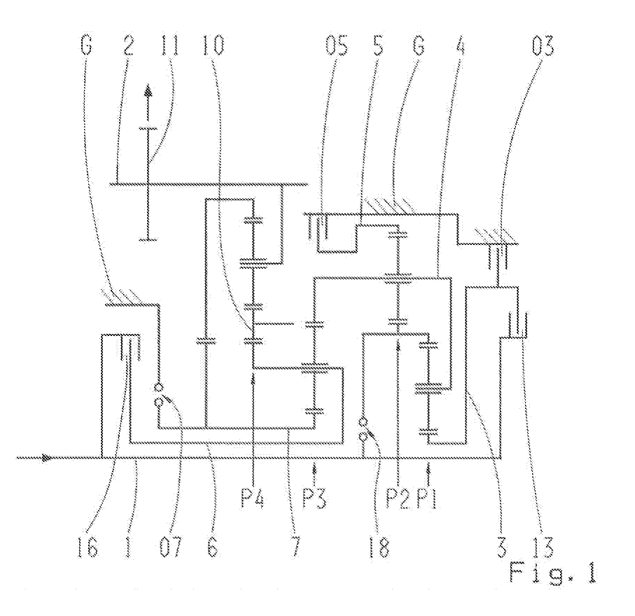

FIG. 1 shows a multi-speed transmission in accordance with an exemplary embodiment of the invention with a drive shaft 1 and an output shaft 2, which are arranged in a housing G, whereas the output shaft 4 is arranged in a manner offset to the axis to the drive shaft 1. Four planetary sets P1, P2, P3 and P4 are provided, whereas the first and the second planetary sets P1, P2 are designed as negative planetary sets and form a shiftable upstream gear set, and whereas the third and the fourth planetary gear sets P3, P4 form the main gear set.

As shown in FIG. 1, six shifting elements (i.e., a first brake 03, a second brake 05 and a third brake 07 along with a first clutch 13, a second clutch 16 and a third clutch 18) are provided. The spatial arrangement of the shifting elements may be arbitrary, and is limited only by the dimensions and the external shaping. In particular, in addition to the arrangement shown of the second clutch 16 in an axial direction in front of all planetary sets P1, P2, P3 and P4, the second clutch 16 may also be arranged in an axial manner between the upstream gear set P1, P2 and the main gear set P3, P4. Furthermore, in addition to the arrangement shown of the third brake 07, such third brake 07 may connect the shaft 9 to the housing G.

With the previously described shifting elements 03, 05, 07, 13, 16, 18, a selective shifting of nine forward gears and one reverse gear can be realized.

The exemplary embodiment shown features a total of nine rotating shafts (i.e., a first shaft 1, a second shaft 2, a third shaft 3, a fourth shaft 4, a fifth shaft 5, a sixth shaft 6, a seventh shaft 7, an eighth shaft 8 and a ninth shaft 9).

With the exemplary embodiment shown of the multi-speed transmission in accordance with FIG. 1, the bars of the first and the second planetary sets P1, P2 are coupled to each other through the fourth shaft, which is connected to the ring gear of the planetary set P3 of the main gear set, whereas the ring gear of the first planetary set P1 is coupled with the sun gear of the second planetary set P2 through the eighth shaft 8, which is detachably connectable to the drive shaft 1 through the third clutch 18.

Furthermore, the sun gear of the first planetary set P1 is also attachable to the housing G of the transmission by means of the third shaft 3 through the first brake 3, and is detachably connectable to the drive shaft 1 through the first clutch 13. With the exemplary embodiment shown, the first clutch 13 and the first brake 03 feature a common multi-disk carrier. The ring gear of the second planetary set P2 is attachable to the housing G of the transmission by means of the fifth shaft 5 through the second brake 05.

With the exemplary embodiment shown according to FIG. 1, the sixth shaft 6 is, through an idler gear 10, constantly connected to the ring gear of the fourth planetary set P4 and the bar of the third planetary set P3, and is detachably connectable to the drive shaft 1 through the second clutch 16. The seventh shaft 7 is constantly connected to the sun gear of the third planetary set P3 and, through the ninth shaft 9, is constantly connected to the ring gear of the fourth planetary set P4, and is attachable to the housing G of the transmission through the third brake 07. The output takes place through the output shaft 2 constantly connected to the bar of the fourth planetary set P4.

Accordingly, the idler gear 10 and the fourth planetary set P4 are provided in a coaxial manner to the output shaft 2 formed as an intermediate shaft, which carries a fixed gear 11 as the output gear.

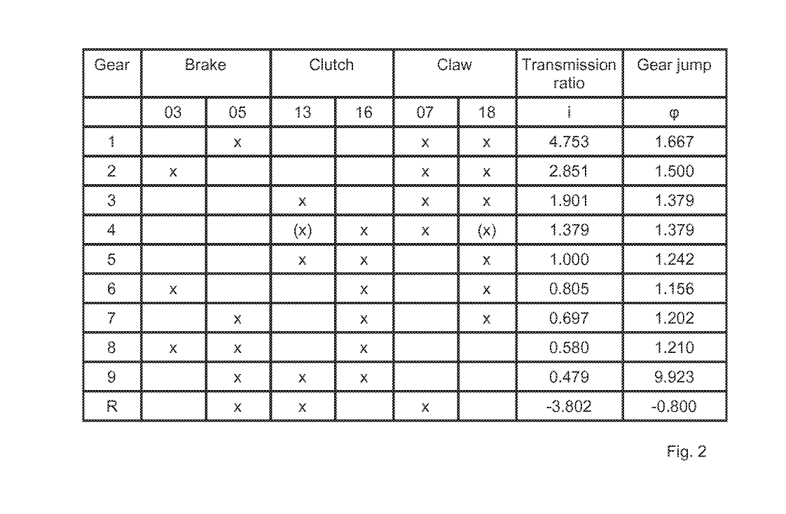

FIG. 2 shows an exemplary shifting diagram of the exemplary embodiment of a multi-speed transmission shown in FIG. 1, whereas it is assumed that the third clutch 18 and the third brake 07 are designed as claw shifting elements (i.e., as claw clutches or claw brakes). For each gear, three shifting elements are locked. As an example, the respective transmission ratios i of the individual gears and the gear steps or progressive steps φ to be determined from these can be seen in the shifting diagram.

The first gear arises through the locking of the third clutch 18 along with the second and third brakes 05, 07, the second gear arises through the locking of the first and third brakes 03, 07 along with the third clutch 18, the third gear arises through the locking of the third brake 07 and the first and third clutches 13, 18 and the fourth gear arises through the locking of the third brake 07 and the second clutch 16, whereas, optionally, another one of the shifting elements (for example, the first clutch 13 in this case) is locked. However, instead of the first clutch 13, the third clutch 18 or the first brake 03 or the second brake 05 may likewise be easily locked. In all cases, only one shifting element is to be actuated when shifting from third to fourth gear, or from fourth to fifth gear, as the case may be.

The fifth gear, which is formed as a direct gear, is obtained through the locking of the first, second and third clutches 13, 16, 18; the sixth gear is obtained through the locking of the first brake 03 along with the second and third clutches 16, 18. With locked second and third clutches 16, 18, and the locking of the second brake 05, the seventh gear is obtained. The eighth gear arises through the locking of the first and second brakes 03, 05 and the second clutch 16, and the ninth gear arises through the locking of the second brake 05 and the first and second clutches 13, 16. As is also shown in the shifting diagram in accordance with FIG. 2, the reverse gear arises through the locking of the second and third brakes 05, 07 and the first clutch 13.

The shifting matrix presented in FIG. 2, in particular the transmission ratios and gear jumps shown therein, arise through the steel transmission ratio of the four planetary sets P1, P2, P3, and P4 of −2, −1.5, −2.64 and −2.64, respectively.

Given the fact that the second brake 05 and the third brake 07 are locked in a first forward gear and in the reverse gear, such shifting elements designed as frictional shifting elements may be used as start-up elements. In addition or as an alternative, the drive shaft can be separated by a coupling element of a drive motor. It is also possible to arrange an external start-up element behind the transmission in the direction of the power flow. With this alternative design, the drive shaft is typically firmly connected to the crankshaft of the motor.

It is also possible to provide additional freewheels at each suitable location of the multi-speed transmission, for example between one shaft and the housing, or, if applicable, in order to connect two shafts.

In accordance with exemplary aspects of the invention, an axle differential and/or a distributor differential may be arranged on the input side or on the output side.

Within the framework of an advantageous additional form, if necessary, the input shaft 1 may be separated from the drive motor by a coupling element, whereas a hydrodynamic converter, a hydraulic clutch, a dry starting clutch, a wet starting clutch, a motor separating clutch, a magnetic powder clutch or a centrifugal clutch may be used as the coupling element. It is also possible to arrange such a start-up element in the direction of the power flow behind the transmission, whereas, in this case, the input shaft 1 is constantly connected to the crankshaft of the motor.

The multi-speed transmission in accordance with exemplary aspects of the invention also allows for the arrangement of a torsional vibration damper between the motor and the transmission.

Within the framework of an additional exemplary embodiment of the invention that is not shown, a wear-free brake, such as a hydraulic retarder or an electric retarder or the like, may be arranged at each shaft, preferably at the input shaft 1 or the output shaft 2; this is of particular importance for use in commercial vehicles. Furthermore, a power take-off may be provided to drive additional power units at each shaft, preferably at the input shaft 1 or the output shaft 2.

The frictional shifting elements that are used may be formed as power-shifting clutches or brakes. In particular, force-fitting clutches or brakes, such as multi-disk clutches, band brakes and/or cone clutches, may be used.

An additional advantage of the multi-speed transmission presented here is that an electric motor can be installed at each shaft as a generator and/or as an additional drive motor.

Modifications and variations can be made to the embodiments illustrated or described herein without departing from the scope and spirit of the invention as set forth in the appended claims.

### REFERENCE SIGNS

1 Drive shaft
2 Output shaft
3 Third shaft
4 Fourth shaft
5 Fifth shaft
6 Sixth shaft
7 Seventh shaft
8 Eighth shaft
9 Ninth shaft
10 Idler gear
11 Fixed gear
03 First brake
05 Second brake
07 Third brake
13 First clutch
16 Second clutch
18 Third clutch
P1 First planetary set
P2 Second planetary set
P3 Third planetary set
P4 Fourth planetary set
i Transmission ratio
φ Progressive step
G Housing

1-11. (canceled)

12. An automatic transmission, comprising:
a housing;
a drive shaft;
an output shaft;
a plurality of planetary gear sets positioned within the housing and having a first planetary gear set, a second planetary gear set, a third planetary gear set and a fourth planetary gear set, each gear set of the plurality of planetary gear sets comprising a sun gear, a planetary carrier and a ring gear; and
a plurality of shifting elements positioned within the housing and having a first brake, a second brake, a third brake, a first clutch, a second clutch and a third clutch, the shifting elements of the plurality of shifting elements configured for selective actuation in order to provide at least nine forward gears and one reverse gear, each forward gear of the at least nine forward gears having a different transmission ratio between the drive shaft and the output shaft,
wherein the planetary carriers of the second and fourth planetary gear sets are radially offset from the planetary carriers of the of the first and third planetary gear sets.

13. The automatic transmission of claim 12, wherein the first planetary gear set, the second planetary gear set and the third planetary gear set are arranged on an axial direction of the drive shaft in the order of the first planetary gear set, the third planetary gear set and the fourth planetary set planetary gear set or in the order of the fourth planetary gear set, the third planetary gear set and the first planetary gear set, the second planetary gear set arranged between the first planetary gear set and the third planetary gear set or above the first planetary gear set or on a side of the first planetary gear set turned away from the third planetary gear set.

14. The automatic transmission of claim 12, wherein the second clutch is positioned between the third planetary gear set and the first planetary gear set along the axial direction.

15. The automatic transmission of claim 12, wherein the first clutch is configured for selectively connecting the drive shaft to the sun gear of the first planetary gear set, the first brake configured for selectively connecting the sun gear of the first planetary gear set to the housing, the ring gear of the first planetary gear set connected to the sun gear of the second planetary gear set, the planetary carrier of the first planetary gear set connected to the planetary carrier of the second planetary gear set and the ring gear of the third planetary gear set, the third clutch configured for selectively coupling the ring gear of the first planetary gear set and the sun gear of the second planetary gear set to the drive shaft, the ring gear of the second planetary gear set connected to the housing, the third brake configured for selectively connecting the sun gear of the third planetary gear set to the housing.

16. The automatic transmission of claim 15, further comprising an idler gear, the planetary carrier of the third planetary gear set connected to the idler gear, the second clutch configured for selectively connecting the planetary carrier of the third planetary gear set to the drive shaft, the idler gear meshing with the sun gear of the fourth planetary gear set, the planetary carrier of the fourth planetary gear set connected to the output shaft.

17. The automatic transmission of claim 12, further comprising an idler gear, the ring gear of the fourth planetary gear set connected through the idler gear to the sun gear of the third planetary gear set, the third brake configured for selectively connecting the ring gear of the fourth planetary gear set through the idler gear to the housing .

18. The automatic transmission of claim 12, wherein the output shaft comprises an output gear.

19. The automatic transmission of claim 12, wherein at least one of the third clutch or the third brake is a claw shifting element.

20. The automatic transmission of claim 12, wherein one of the second brake, the third brake, the third clutch or the second brake comprises a start-up element.

21. The automatic transmission of claim 12, wherein the third clutch and the second and third brakes are closed in a first forward gear of the at least nine forward gears, the first and third clutches and the third brake are closed in a second forward gear of the at least nine forward gears, the first and third clutches and the third brake are closed in a third forward gear of the at least nine forward gears, the second clutch, the third brake and one of the first brake, the second brake, the first clutch or the third clutch are closed in a fourth forward gear of the at least nine forward gears, the first, second and third clutches are closed in a fifth forward gear of the at least nine forward gears, the second and third clutches and the first brake are closed in a sixth forward gear of the at least nine forward gears, the second and third clutches and the second brake are closed in a seventh forward gear of the at least nine forward gears, the second clutch and the first and second brakes are closed in an eighth forward gear of the at least nine forward gears, the first and second clutches and the second brake are closed in a ninth forward gear of the at least nine forward gears.

22. The automatic transmission of claim 12, wherein the first clutch and the second and third brakes are closed in the reverse gear.
